(19) United States
(12) Patent Application Publication
(10) Pub. No.: US 2006/0231719 A1
(43) Pub. Date: Oct. 19, 2006

(54) Seat slide apparatus

(76) Inventors: Tetsuya Kayumi, Wako-shi (JP); Hirohide Suda, Wako-shi (JP); Akinori Mori, Inuyama-shi (JP); Masashi Mitsukuchi, Inuyama-shi (JP)

Correspondence Address: CANTOR COLBURN, LLP, 55 GRIFFIN ROAD SOUTH, BLOOMFIELD, CT, 06002, US

(21) Appl. No.: 11/339,168

(22) Filed: Jan. 25, 2006

(30) Foreign Application Priority Data
Jan. 25, 2005 (JP) JP 2005-016595

(51) Int. Cl. F16M 13/00

(52) U.S. Cl. 248/429

(57) ABSTRACT

A simply structured and inexpensive seat slide apparatus, which, in an ordinary front/rear position adjustment of a seat, allows a passenger to operate manually without using a power drive unit; and in walk-in operation only, enables the seat to slide swiftly using the power drive unit.

### CROSS REFERENCE TO RELATED APPLICATION

The present invention claims priority under 35 U.S.C. §119 to Japanese Application No. 2005-016595 filed Jan. 25, 2005, which is incorporated herein by reference.

### FIELD OF INVENTION

The present invention relates to a seat slide apparatus having a lower rail member firmly fixed to a floor face of a vehicle and an upper rail member mounted with a seat cushion, which is capable of adjusting the position of a seat for the vehicle forward and backward, in particular to a seat slide apparatus arranged so that the upper rail member and the lower rail member are connected to each other via a traction member such as a wire, and by pulling the traction member with a power unit, the upper rail member can be slid on the lower rail member.

### BACKGROUND

In one-box type vehicles represented by “minivan” or “cab wagon”, many types of vehicles are equipped with three row seats in the interior. With respect to a seat disposed in the third row, (referred to as “third row seat”), generally passengers get on and off using a rear door. However, when passengers get on the third row seats, the seat disposed immediately before these seats (referred to as “second row seat”) obstructs the path for getting on and off. Therefore, the second row seat is provided with a “walk-in function” for allowing the second row seat to slide (move) forward (or backward).

As for the “walk-in function”, as disclosed in Japanese Patent Application Laid-Open No. H 06-328973 and Japanese Patent Application Laid-Open No. H 08-126541, conventionally there are well-known arts such that the walk-in function is activated by an operation at the driver's seat or inclination of a seat back, forward/backward movement of the seat and the like are carried out by means of an electrical control.

Also, vehicles such as minivan are in a trend such that a variety of seat arrangements are required to respond various mode of use and purpose of users. The followings are typical examples of seat arrangements; i.e., space of cargo room is increased by largely moving the second and third row seat forward and backward respectively; or the second row seat and the third row seats are brought closer to each other and the seat back of the second row seat is inclined forward; thereby, the back face of the second row seat is used as a table and the like.

In order to achieve various seat arrangements as described above, in many cases, a “long rail” is employed to install the second row seat and the like to the vehicle floor face. Here, the wording “long rail” ordinary means the lower rail in the seat slide apparatus. However, the wording “long rail” sometimes used to indicate the seat slide apparatus itself equipped with a lower rail, which is further longer than the lower rail of a seat slide apparatus used for driver's seat (passenger seat).

Since the long rail has a wide movable range, when a passenger slides the seat on the long rail in a wide range by hand (manual operation), the passenger suffers a workload. Accordingly, an arrangement such that a power drive unit is used for the long rail (power seat system) is appropriately employed.

As for the power seat system, “an arrangement of a combination of a lead screw and a nut”, “an arrangement of combination of a rack and a pinion” or the like, which have been conventionally provided to a seat slide apparatus of an ordinary length, may be employ.

However, as it reads, since the long rail is structured using a long member, a deflection and/or a deformation are easily generated particularly in the longitudinal direction. Therefore, it is difficult to fit the “lead screw & nut” or “rack & pinion” in full length of the long rail with high precision. Also, in the case where a system of the “lead screw & nut” or the “rack & pinion” is employed and when the driving speed is increased, large noises and vibrations maybe generated resulting in an uncomfortable feeling to the passengers.

As a solution of the above problems, Japanese Patent Application Laid-Open No. 2004-243811 discloses “a structure for sliding an upper rail member by winding traction member such as a wire.” In this technique, even when a small deflection or deformation is included in a lower rail, the traction member pulls an upper rail member along the deflection/deformation. Therefore, the upper rail member can be slid reliably and satisfactory silence is also achieved. In this point, this technique is a superior technique.

However, there resides a problem in the technique disclosed in the Japanese Patent Application Laid-Open No. 2004-243811 such that, irrespective of the situation whether the seat is in a walk-in operation or in an ordinary front/rear position adjustment, the upper rail member has to has a constitution to be always slid (moved) at a constant speed. That is, to carry out the ordinary front/rear position adjustment of the seat, since the seat has to be locked (prevention of sliding) at a short pitch (distance) of 20-30 mm, the sliding speed of the upper rail member has to be set to a relatively slow speed. When the walk-in function is activated and the seat is made to slide a long distance under such speed setting, the sliding movement is felt to be too slow.

Considering the situation where the walk-in function is activated, when the second row seat is caused to slide forward swiftly, the passengers can get into the interior quickly. Therefore, when the walk-in operation is used, the seat has to be made to slide at a fast speed. Particularly, in a rainy situation when a passenger with no umbrella activates the walk-in function to get on the third row seat, it is strongly required for the seat to be slid (moved) at a high speed.

In the technique disclosed in Japanese Patent Application Laid-Open No. 2004-243811 also, the sliding speed of the seat under the walk-in operation can be increased by electrically controlling the sliding movement. In this case, there arises such a problem that various control devices are additionally required resulting in an increase of manufacturing process and cost. Further, there arises such a problem that the risk of trouble is increased due to the complicated apparatus itself.

Further, in the technique disclosed in the Japanese Patent Application Laid-Open No. 2004-243811, there resides such a problem that, irrespective of the situation whether the seat is in a walk-in operation or in an ordinary front/rear position adjustment, the seat has to have a constitution to be always slid by a driving force (motor). Generally, it is the second row seat located in the vicinity of the rear door that has to be given with the walk-in function. In many cases, the second row seat is designed for three passengers. That is, to fine adjust the front/rear position of the seat, even in a state when three passengers sit on the seat and the entire weigh is applied to the seat, the seat has to be slid forward/backward by driving a motor and winding a wire cable. To this end, a large diameter (high strength) wire cable has to be wound with a motor of a high output capacity. This inevitably leads to such a problem that the weight and cost of the apparatus itself is increased.

Furthermore, in the case where the seat is made to slide using a power drive unit in a state passengers sit on the seat, there resides such a problem to the sliding speed of the seat has to be controlled to a low speed in order to ensure the safety of the passenger and to obtain a satisfactory torque of the motor.

The present invention has been proposed at least in view of the above-described problems. The inventor found the fact that, by combining a manual seat system and a power seat system, and when passengers sit on the seat, the seat is made to slide in a manner of a manual operation by a passenger; and only when no passenger sits on the seat, the seat is made to slide by a power drive unit; thereby a swift walk-in operation can be achieved.

Patent Document 1

Japanese Patent Application Laid-Open No. H 06-328973

Patent Document 2

Japanese Patent Application Laid-Open No. H 08-126541

Patent Document 3

Japanese Patent Application Laid-Open No. 2004-243811

### BRIEF DESCRIPTION OF THE INVENTION

An embodiment of the present invention provides a inexpensive seat slide apparatus having a simple structure, which is capable of being operated manually by a passenger without using a power drive unit when carrying out an ordinary front/rear position adjustment of the seat; and only when carrying out the walk-in operation, a swift sliding of the seat can be obtained by using the power drive unit.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a perspective view of a seat slide apparatus 100 in accordance with an embodiment of the present invention.

FIG. 2 is a side view of the seat slide apparatus 100 shown in FIG. 1.

FIG. 3 is a cross sectional view of the seat slide apparatus 100 taken along the line A-A shown in FIG. 2.

FIG. 4 is a partial plane view of the seat slide apparatus 100 shown in FIG. 2.

FIG. 5 is a side view of an upper rail member 10 in the seat slide apparatus 100 shown in FIG. 1.

FIG. 6 is a side view of the upper rail member 10 shown in FIG. 5 viewed from the other side.

FIG. 7 is a perspective view of a power drive unit constituted of a rotation dram 60, a motor 70 and a clutch 80, which is included in the seat slide apparatus 100 shown in FIG. 1.

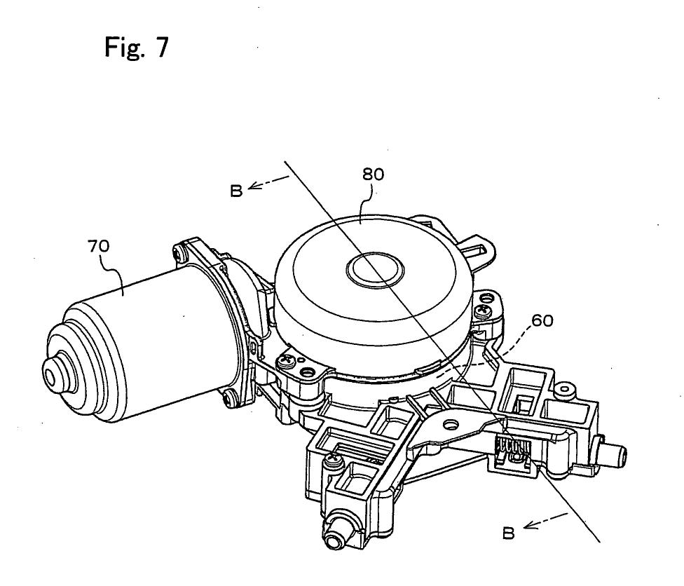

FIG. 8 is a cross sectional view of the power drive unit shown in FIG. 7 taken along the line B-B.

FIG. 9 is a block diagram showing forward walk-in operation of the seat slide apparatus 100 in accordance with the present invention.

FIG. 10 is a block diagram showing backward walk-in operation of the seat slide apparatus 100 in accordance with the present invention.

### DETAILED DESCRIPTION

First, a seat slide apparatus 100 includes an upper rail member 10 capable of mounting a seat cushion; a lower rail member 20 capable of being firmly fixed to a floor face of a vehicle; a locking unit 30 disposed to the upper rail member 10 for locking and unlocking relative movement of the upper rail member 10 with respect to the lower rail member 20; an operation lever 90 connected to the locking unit 30 capable of being manually operated to lock and unlock the locking unit 30 by a passenger; a unlocking device 40 connected to the locking unit 30 for locking and unlocking the locking unit 30 using a power; a traction member 50 for pulling the upper rail member 10, of which both ends are connected to the front and the rear ends of the lower rail member 20; a rotation drum 60 disposed on the rear side of the upper rail member 10 or seat cushion for winding the traction member 50; a motor 70 connected to a rotation drum 60 for rotating the rotation drum 60; clutch 80 for transmitting driving force of the motor 70 to the rotation drum 60; a first switch SW1 disposed on the surface of an interior wall for activating the unlocking device 40, the motor 70 and the clutch 80; and a second switch SW2 disposed in a front area of the lower rail member 20 for inactivating the unlocking device 40, the motor 70 and the clutch 80 after the upper rail member 10 has been slid forward.

A seat slide apparatus 100 may also comprise an upper rail member 10 capable of mounting a seat cushion; a lower rail member 20 capable of being firmly fixed to a floor face of a vehicle; a locking unit 30 disposed to the upper rail member 10 for locking and unlocking relative movement of the upper rail member 10 with respect to the lower rail member 20; an operation lever 90 connected to the locking unit 30 capable of being manually operated to lock and unlock the locking unit 30 by a passenger; a unlocking device 40 connected to the locking unit 30 for locking and unlocking the locking unit 30 using a power; a traction member 50 for pulling the upper rail member 10, of which both ends are connected to the front and the rear ends of the upper rail member 10; a rotation drum 60 disposed on the lower rail member 20 or vehicle floor face for winding the traction member 50; a motor 70 connected to a rotation drum 60 for rotating the rotation drum 60; a clutch 80 for transmitting driving force of the motor 70 to the rotation drum 60; a first switch SW1 disposed on the surface of an interior wall for activating the unlocking device 40, the motor 70 and the clutch 80; and a second switch SW2 disposed in a front area of the lower rail member 20 for inactivating the unlocking device 40, the motor 70 and the clutch 80 after the upper rail member 10 has been slid forward.

Further, the invention in accordance with claim 3 is the seat slide apparatus 100 according to claim 1 or 2, further comprising a third switch SW3 disposed in substantially central area of the lower rail member 20 for inactivating the unlocking device 40, the motor 70 and the clutch 80 after the upper rail member 10 has been slid backward.

Owing to the above-described arrangement, the following effects are obtained.

When the first switch SW1 disposed on the interior wall surface is turned ON, the unlocking unit 40, the motor 70 and the clutch 80 are activated. When the unlocking unit 40 is activated, the prevention against the relative movement of the upper rail members 10 with respect to the lower rail members 20 by the locking unit 30 is released and the motor 70 and the clutch 80 are activated. The driving force of the motor 70 is transmitted to the rotation dram 60, and the rotation dram 60 winds the traction member 50; thus the upper rail members 10 are slid (moved) forward. When the upper rail member 10 reaches the second switch SW2 and comes into contact therewith and the second switch SW2 is turned ON, the unlocking unit 40, the motor 70 and the clutch 80 are inactivated; thus, the relative movement of the upper rail members 10 with respect to the lower rail members 20 is locked with the locking unit 30.

That is, it is possible for a passenger not only to complete the walk-in operation only by operating the first switch SW1 to turn ON but also to make the upper rail members 10 to slide forward/backward by manually operating the handle lever 90.

Ordinarily, when the walk-in is activated, since the seat is made to slide at a high speed, no passenger sits on the seat, the traction member 50 wound by the rotation dram 60 and the motor 70 for rotating the rotation dram 60 do not have to support the weigh of passengers. Therefore, the traction member 50 is not required to be highly strong nor the motor 70 is not required for a large output. Therefore, the weight and cost for the seat slide apparatus 100 itself can be reduced.

Furthermore, when the third switch SW3 for inactivating the unlocking unit 40, the motor 70 and the clutch 80 are provided in the substantially central portion of the lower rail member 20, by rotating the motor 70 in reverse, the upper rail members 10 is made to slide (move) backward. When the upper rail member 10 comes into contact with the third switch SW3 and the third switch SW3 is turned ON, the unlocking unit 40, the motor 70 and the clutch 80 are inactivated, the relative movement of the upper rail members 10 with respect to the lower rail members 20 is locked by the locking unit 30.

A seat slide apparatus 100 will be described below with reference to an embodiment thereof.

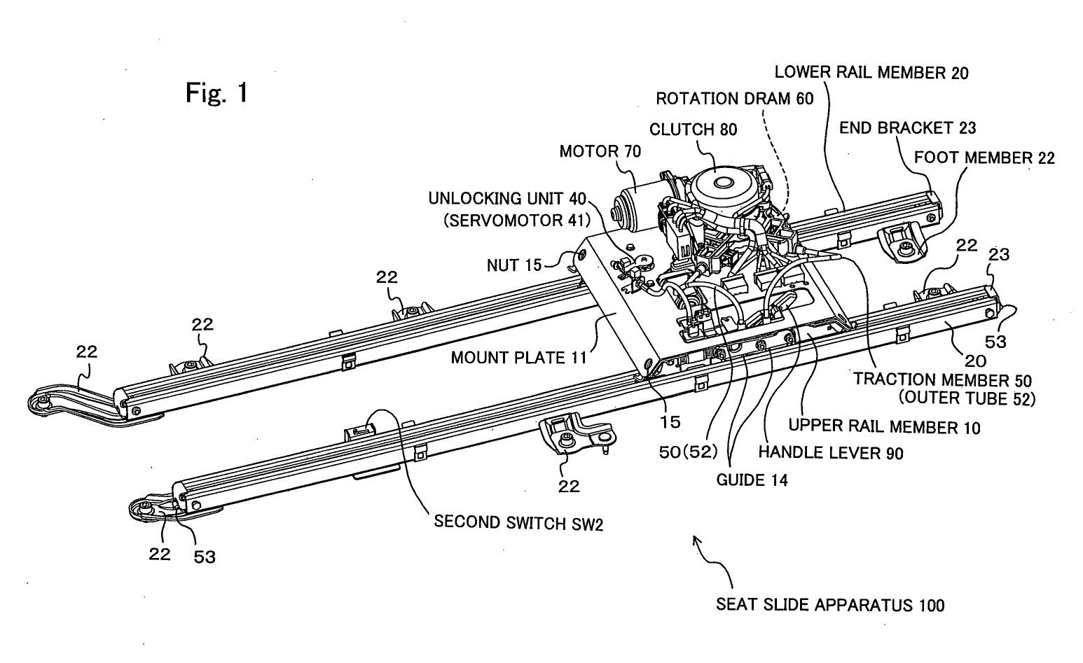

The seat slide apparatus 100 in accordance with the embodiment is used mainly when a second row seat is installed in a vehicle such as a minivan. As shown in FIG. 1, the seat slide apparatus 100 has an upper rail member 10, a lower rail member 20, a locking unit 30, an unlocking unit 40, a traction member 50, a rotation dram 60, a motor 70, a clutch 80 and the like. Each component element will be described below.

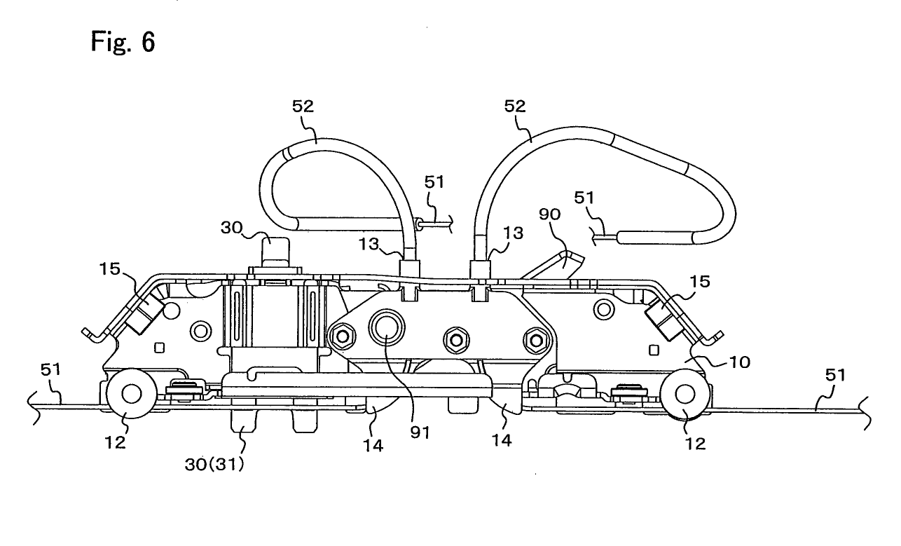

The upper rail member 10 is disposed at the right and left sides of a seat for a vehicle to allow a seat cushion to be mounted thereon. If the upper rail member 10 is capable of mounting a seat cushion, any upper rail member having any shape or structure may be employed. In this embodiment, as shown in FIGS. 1 to 6, a steel plate is formed into a substantially right and left symmetrical shape by means of press; and these rails are disposed in positions opposite to each other.

In this embodiment, in the upper rail member 10, two cylindrical wire-insertion ports 13 are provided being aligned in the front-rear direction extending upward from a cut formed in the upper face of the upper rail member 10. The wire-insertion ports 13 are used as ports for inserting inner wires 51 from a rotation dram 60, which will be described later. Also, below the wire-insertion ports 13, guide portions 14 are provided communicating with each other. The guide portions 14 are for guiding the inner wires 51 inserted from the wire-insertion ports 13 to the inside of the lower rail member 20 and for changing the direction of the inner wires 51 in a gentle arc shape toward the end portion of the lower rail member 20. The guide portions 14 are formed in a groove-like shape, and at least for the sliding surface of the groove in which the wire slides, a material such as a resin of a small resistance is preferably employed.

As shown in FIG. 1, in this embodiment, between a pair of upper rail members 10, a mount plate 11 of a plate-like member is provided for mounting the rotation dram 60, the motor 70, the clutch 80 and the like. The dimensions of the width of the mount plate 11 are arbitrarily determined in accordance with the distance between the lower rail members 20, which will be described later.

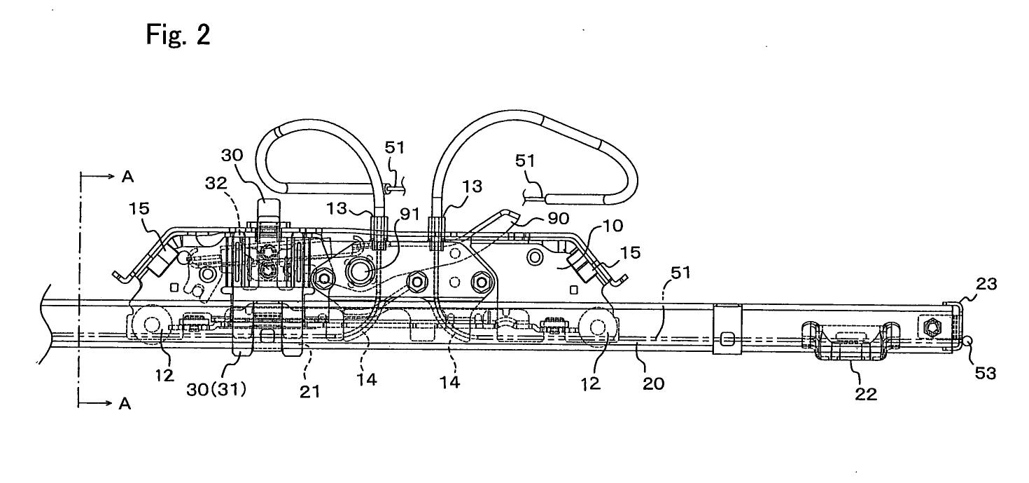

As shown in FIGS. 2, 3, 5 or 6, on the lower portion of the upper rail member 10, rollers 12 are pivoted. Owing to the rotational movement of the rollers 12 inside the lower rail members 20 (which will be described later), the upper rail members 10 are allowed to slide smoothly with respect to the lower rail members 20. To the upper rail members 10, nuts 15 for mounting a seat are fixed in a manner of welding. A seat cushion is placed on the upper rail members 10 and fastened with bolts to the nuts 15; thus, the seat cushion can be mounted and fixed therewith.

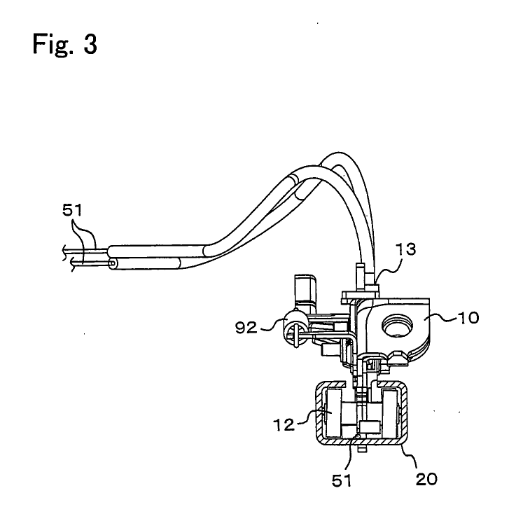

The lower rail members 20 are for firmly fixing the seat slide apparatus 100 to the floor face of the vehicle, and for slidably supporting the upper rail members 10. If the lower rail members 20 are firmly fixed to the floor face of the vehicle and the upper rail members 10 are allowed to slide, any shape and structure thereof may be employed. In this embodiment, as shown in FIG. 3, a copper plate is bent into a substantially C-like shape in cross section having an opening on the top in a manner of press. And a pair of the right and left cylindrical members is disposed at positions opposite to each other. Particularly, in this embodiment, as shown in FIG. 1, a long lower rail member 20 called as long rail is employed. Considering the case where a single seat is mounted, the distance between the lower rail members 20 is prescribed to a relatively narrow distance. Needless to say, the distance between the lower rail members 20 is not particularly limited to the above constitution. The distance may be arbitrarily determined in accordance with the width of the seat for the vehicle to be mounted thereon. On the bottom face of the lower rail members 20, foot members 22 used for firmly fixing the lower rail members 20 to the floor face of the vehicle are fixed in a manner of welding.

Also, to the both ends of the lower rail members 20, an end bracket 23 is attached respectively to cover the sectional opening. In a substantially central portion of the end bracket 23, a slit is formed for allowing a wire end 53 to be hooked, which will be described later. The width of the slit is prescribed to a width slightly larger than the diameter of an inner wire 51 that the wire end 53 cannot pass therethrough, which will be described later.

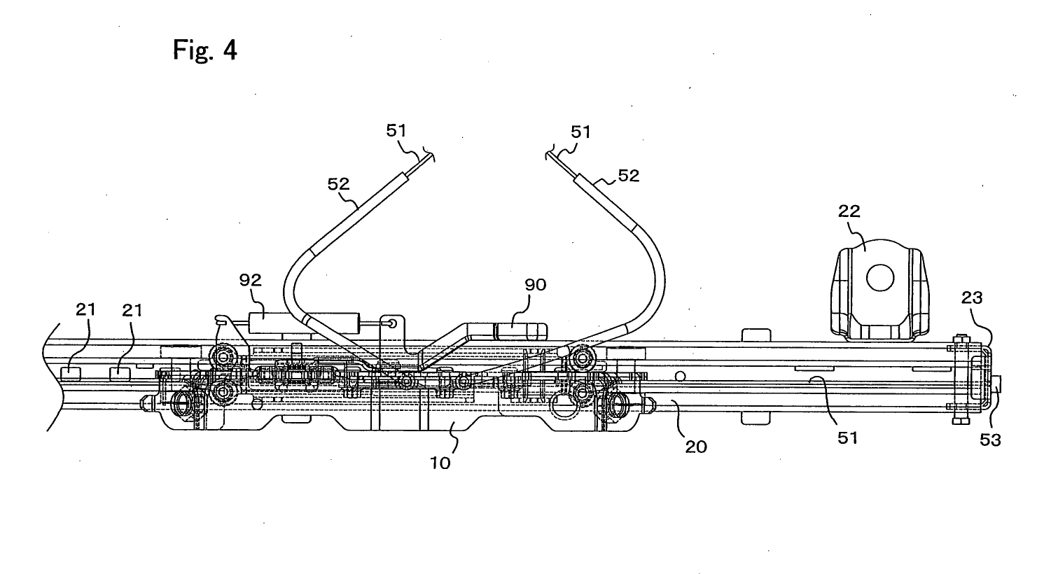

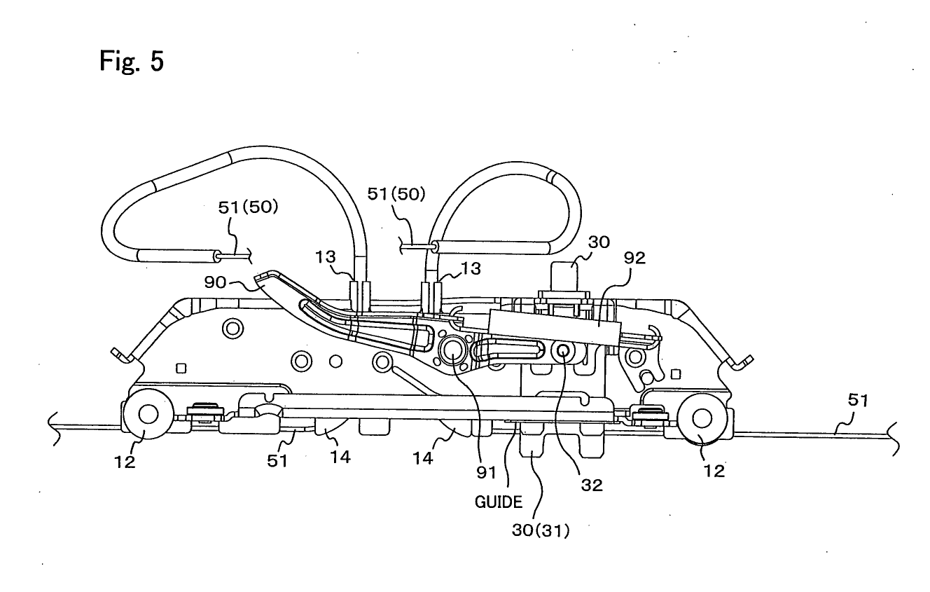

The locking unit 30 is for preventing a relative movement of the upper rail members 10 with respect to the lower rail members 20. If the upper rail members 10 can be prevented from sliding with respect to the lower rail members 20 and fixed thereby, any shape and/or structure of the locking unit 30 may be employed. This embodiment employs the following constitution as shown in FIG. 2 or FIG. 4. That is, a lock lever 31 having projections capable of being inserted and engaged with rocking holes 21 is provided slidably in the vertical direction within the guide portions formed on the upper rail members 10. The rocking holes 21 are continuously formed in the longitudinal direction inside the lower portion of the lower rail members 20. The lock lever 31 is connected to the unlocking unit 40, which will be described later, and to a handle lever 90 that is operated manually by a passenger. As shown in FIG. 5, a cylindrical convex member 32 is implanted in the side face of the lock lever 31, and in a central portion of the handle lever 90, a pin 91 is provided penetrating the handle lever 90 to rotatably pivot the handle lever 90 with respect to the upper rail member 10. The handle lever 90 is energized with a coil spring 92 so that the handle lever 90 presses the lock lever 31 via the convex portion 32 to maintain the state that the lock lever 31 is engaged in the rocking holes 21. When a passenger operates the handle lever 90 manually (manual operation), or when the unlocking unit 40 is activated, the lock lever 31 moves forward/backward with respect to the rocking holes 21 formed in the lower rail member 20; thereby the relative movement of the upper rail members 10 with respect to the lower rail members 20 is prevented and released.

The unlocking unit 40 is for releasing the locking by the locking unit 30. If the locking by the locking unit 30 can be released, any shape or structure may be employed for the unlocking unit 40. In this embodiment, as shown in FIG. 1, a servomotor 41 including a small size motor and a speed reduction unit (not shown) is connected to the lock lever 31. It is arranged so that, when the servomotor 41 is activated, the lock lever 31 is moved forward/backward with respect to the rocking hole 21 in the lower rail member 20. Further, it may be arranged so that the servomotor 41 operates the handle lever 90 for manual operation; thereby the locking can be released.

The traction members 50 are for pulling the upper rail members 10. In the present invention, if the upper rail members 10 can be pulled, any shape or structure may be employed for the traction members 50. In this embodiment, as shown in FIG. 1 or FIG. 5, a wire cable including an outer tube 52 and an inner wire 51 is employed. By twisting a plurality of metal wires, the strength of the inner wires 51 is increased and a cylindrical wire end 53 is provided to the both ends respectively. One end of the inner wires 51 is inserted through the wire-insertion port 13 and the guide portion 14 formed in the upper rail member 10 and guided inside the lower rail member 20, and the wire end 53 is hooked to the end bracket 23. The other end of the inner wires 51 is attached to the rotation dram 60 so as to be wound by the rotation dram 60. The portion of the wire from the wire-insertion ports 13 protruding through the cut in the upper end of the upper rail member 10 to the rotation dram 60, the inner wire 51 is inserted through the outer tube 52 to protect the inner wire 51 respectively.

The inner wires 51 are provided to one lower rail member. 20 in the pair of lower rail members 20, but other lower rail member 20 is not provided therewith. Because, in the seat slide apparatus 100, it is assumed that the traction member (wire cable) is wound only when the walk-in operation is carried out in a state that no passenger sits on the seat.

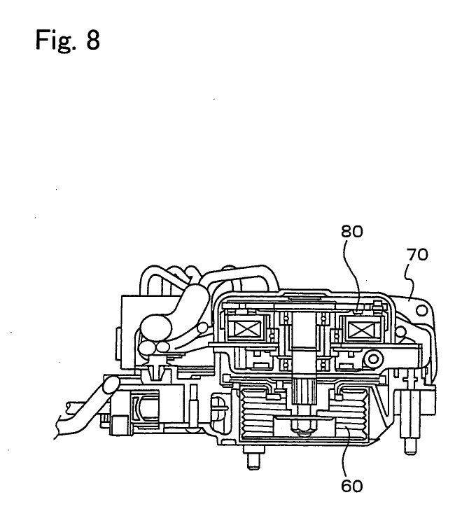

When the motor 70 is activated, which will be described later, the rotation dram 60 rotates to wind the traction member 50. If the traction member 50 can be wound, any shape or structure may be employed for the rotation dram 60. In this embodiment, as shown in FIG. 8, a cylindrical member, which is formed with a spiral groove on the peripheral surface thereof, is employed. And at the upper and lower end portions of the cylindrical member, hooking concave portions for allowing the wire end 53 to be hooked are formed. To the hooking concave portions, the wire end 53 of two inner wires 51 of which wire ends 53 are hooked to the end brackets 23 provided to the front and rear ends of the lower rail members 20, and on the spiral groove on the outer periphery of the cylindrical member, the inner wires 51 are wound.

The motor 70 is connected to the rotation dram 60 to rotate the rotation dram 60. If the motor 70 is capable of rotating the rotation dram 60 being connected thereto, any shape or structure may be employed. In this embodiment, a general-purpose motor, which is used for opening/closing slide door of a vehicle, may be employed.

The clutch 80 is for arbitrarily connecting/disconnecting the motor 70 with the rotation dram 60. When the motor 70 and the rotation dram 60 are connected with each other, the driving force of the motor 70 is transmitted to the rotation dram 60, and the rotation dram 60 follows the motor 70. If the motor 70 and the rotation dram 60 can be arbitrarily connected/disconnected with each other, any shape or structure may be employed for the clutch 80. This embodiment employs a one-way clutch, in which the torque from the motor 70 is transmitted to the rotation dram 60, but the rotation torque from the rotation dram 60 is not transmitted to the motor 70. Owing to the above-described constitution, the manual operation in an ordinary front/rear position adjustment area is not suffered from the resistance of the motor 70. Therefore, the operation can be carried out with the same operation force as that required in the ordinary manual seat slide apparatus 100. Needless to say, the present invention is not limited to the above constitution, but a general electromagnetic clutch or a mechanical clutch may be employed.

A first switch SW1 is disposed on the surface of the interior wall. When a passenger operates the switch to turn ON, the unlocking unit 40, the motor 70 and the clutch 80 are activated. Although not illustrated, in this embodiment, a push-button switch may be disposed on the console panel of the vehicle, in the vicinity of the rear door, or to the seat provided with the walk-in function.

A second switch SW2 is disposed in the vicinity of the front area of the lower rail member 20. When the upper rail member 10 slides forward (walk-in is activated), the upper rail member 10 presses (operates) the switch SW2 to inactivate the unlocking unit 40, the motor 70 and the clutch 80. In this embodiment, as shown in FIG. 1, a limit switch is disposed on the upper face in the forward portion of one lower rail member 10.

A third switch SW3 is disposed in the vicinity of substantially central portion or backward portion of the lower rail member 20. When the upper rail member 10 slides backward (returns to the original position), the upper rail member 10 presses the switch SW3 (operates) to inactivate the unlocking unit 40, the motor 70 and the clutch 80. In this embodiment, the third switch SW3 is not particularly illustrated. Same as the second switch SW2, a limit switch is provided on the upper face of one lower rail member 10. The front/rear position of the switch SW3 is located below the upper rail member 10 in the seat slide apparatus 100 shown in FIG. 1.

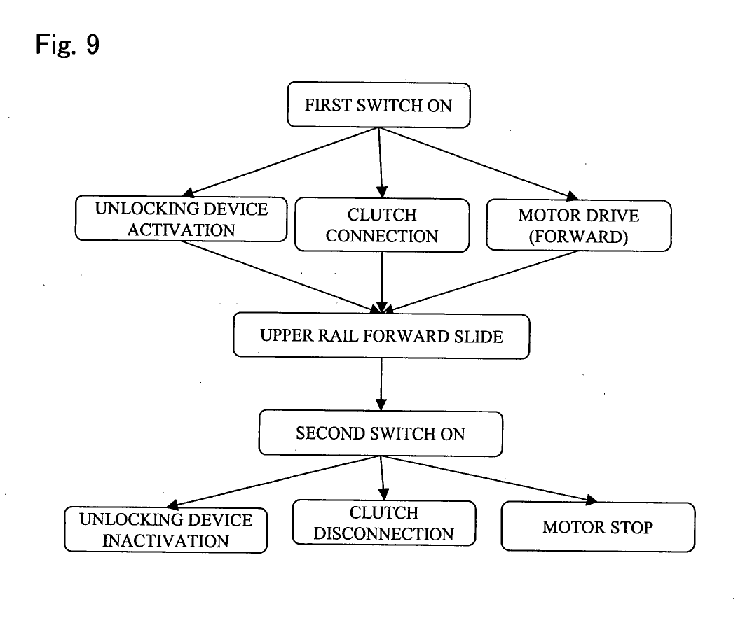

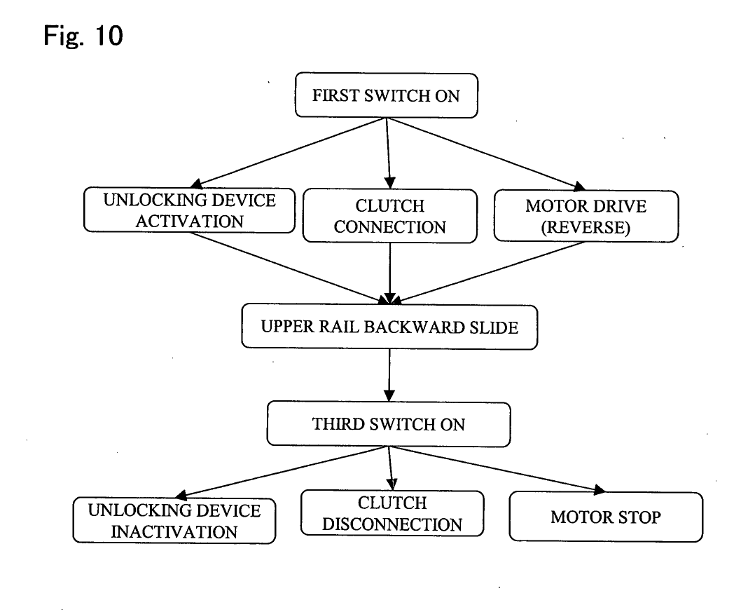

In this embodiment, the above-described motor 70, the clutch 80, the first switch SW1, the second switch SW2 and the third switch SW3 are connected to a control device (not shown) respectively. The control device controls the respective units as illustrated in block diagrams of FIG. 9 or FIG. 10.

In this embodiment, the rotation dram 60, the motor 70, the clutch 80 and the like are disposed on the upper rail member 10. However, the present invention is not particularly limited to the above-described constitution. The rotation dram 60, the motor 70, clutch 80 and the like may be disposed to the vehicle body-side (lower rail member 20). When such constitution is employed, a pulley is attached respectively to the end brackets 23 provided to the ends of a lower rail member 20, the wire end 53 of the inner wires 51 is hooked to the end portions of the upper rail member 10. The inner wires 51 are connected to the rotation dram 60 disposed at the vehicle body-side (lower rail member 20) via the pulley.

Next, the operation of the seat slide apparatus 100 in accordance with this embodiment will be described using the block diagrams shown in FIG. 9 and FIG. 10.

First, the case that the seat is slid forward (walk-in operation) using the driving force of the motor 70 will be described. When the first switch SW1 is turned ON and the unlocking unit 40 is activated by an operation of a passenger, the locking with the locking unit 30 is released. Almost simultaneously, the clutch 80 is connect with the motor 70, and the motor 70 is driven forward; thus, the upper rail member 10 is slid forward. Then, when the upper rail member 10 comes into contact with the second switch SW2, the second switch SW2 is turned ON. The unlocking unit 40 is inactivated and the locking unit 30 is pressed down onto the lower face of the lower rail member 20. Almost simultaneously when the unlocking unit 40 is inactivated, the clutch 80 is disconnected from the motor 70, and the drive of the motor 70 is stopped. While the upper rail member 10 slides through inertia, the locking unit 30 enters into a closest rocking hole 21 and the upper rail member 10 is prevented from sliding.

Next, the case that the seat is slid backward using the driving force of the motor 70 (return to the original position after the walk-in operation) will be described. First, when a passenger operates the first switch SW1 to turn ON, the unlocking unit 40 is activated and the locking with the locking unit 30 is released. Almost simultaneously, the motor 70 is connected with the clutch 80 and driven in the reverse direction to slide the upper rail member 10 backward. After that, when the upper rail member 10 comes into contact with the third switch SW3, the third switch SW3 is turned ON. The unlocking unit 40 is inactivated and the locking unit 30 is pressed down onto the lower face of the lower rail member 20. Almost simultaneously when the unlocking unit 40 stops, the clutch 80 is disconnected and the motor 70 is stopped from driving. While the upper rail member 10 slides through inertia, the locking unit 30 enters into a closest rocking hole 21 and the sliding is prevented. The present invention is not particularly limited to this arrangement. The following arrangement may be employed. That is, the “return to the original position” may be arranged so that, after walk-in operation, a passenger sitting on the third row seat pull the seat back of the second row seat manually to return the second row seat to the position; or, a passenger sitting on the second row seat manually pushes the seat back of the second row seat backward to return the second row seat to the original position.

Next, the case that the seat is slid forward (forward fine adjustment) manually (manual operation) by a passenger will be described. First, when the handle lever 90 is pushed down, the locking unit 30 (lock lever 31) is pulled out from the rocking hole 21 to release the locking by the locking unit 30. Then a forward force is given to the upper rail member 10 to make a slide forward. Then, before the rocking hole 21 for locking the slide, the handle lever 90 is returned (released). The projection of the locking unit 30 proceeds while sliding on the lower inside surface of the lower rail member 20; thus, enters into the rocking hole 21 and the sliding is locked. Here, the clutch 80 is in a disconnected state, a light operation touch is obtained without receiving any resistance from the motor 70 and the traction member 50.

Next, the case that the seat is slid backward (backward fine adjustment) manually (manual operation) by a passenger will be described. First, when the handle lever 90 is pushed down, the locking unit 30 (lock lever 31) is pulled out from the rocking hole 21 to release the locking by the locking unit 30. Then a backward force is given to the upper rail member 10 to make a slide backward. Then, before the rocking hole 21 for locking the slide, the handle lever 90 is returned (released). The projection of the locking unit 30 proceeds while sliding on the lower inside surface of the lower rail member 20 and enters into the rocking hole 21, thus, the sliding is locked. Here, the clutch 80 is in a disconnected state, a light operation touch is obtained without receiving any resistance from the motor 70 and the traction member 50.

While the preferred embodiments of the present invention have been described using specific terms, such description is for illustrative purposes only, and it is to be understood that changes and variations may be made without departing from the spirit or scope of the appended claims.

1. A seat slide apparatus, comprising:
an upper rail member capable of mounting a seat cushion;
a lower rail member capable of being firmly fixed to a floor face of a vehicle;
a locking unit disposed on the upper rail member for locking and unlocking relative movement of the upper rail member with respect to the lower rail member;
an operation lever connected to the locking unit capable of being manually operated to lock and unlock the locking unit by a passenger;
an unlocking device connected to the locking unit for locking and unlocking the locking unit using a powered operation;
a traction member for pulling the upper rail member, of which both ends are connected to the front and the rear ends of the lower rail member;
a rotation drum disposed on the rear side of the upper rail member or seat cushion for winding the traction member;
a motor connected to a rotation drum for rotating the rotation drum;
a clutch for transmitting driving force of the motor to the rotation drum;
a first switch disposed on the surface of an interior wall for activating the unlocking device, the motor and the clutch;
and a second switch disposed in a front area of the lower rail member for inactivating the unlocking device, the motor and the clutch after the upper rail member has been slid forward.

2. A seat slide apparatus, comprising:
an upper rail member capable of mounting a seat cushion;
a lower rail member capable of being firmly fixed to a floor face of a vehicle;
a locking unit disposed on the upper rail member for locking and unlocking relative movement of the upper rail member with respect to the lower rail member;
an operation lever connected to the locking unit capable of being manually operated to lock and unlock the locking unit by a passenger;
an unlocking device connected to the locking unit for locking and unlocking the locking unit using a powered operation;
a traction member for pulling the upper rail member, of which both ends are connected to the front and rear ends of the upper rail member;
a rotation drum disposed on the rear side of the lower rail member or the vehicle floor face for winding the traction member;
a motor connected to a rotation drum for rotating the rotation drum;
a clutch for transmitting driving force of the motor to the rotation drum;
a first switch disposed on the surface of an interior wall for activating the unlocking device, the motor and the clutch;
and a second switch disposed in a front area of the lower rail member for inactivating the unlocking device, the motor and the clutch after the upper rail member has been slid forward.

3. The seat slide apparatus according to claim 1, further comprising a third switch disposed in a substantially central area of the lower rail member for inactivating the unlocking device, the motor and the clutch after the upper rail member has been slid backward.

4. The seat slide apparatus according to claim 2, further comprising a third switch disposed in a substantially central area of the lower rail member for inactivating the unlocking device, the motor and the clutch after the upper rail member has been slid backward.
